(19) United States
(12) Patent Application Publication
(10) Pub. No.: US 2021/0285278 A1
(43) Pub. Date: Sep. 16, 2021

(54) INSULATING GLAZING AND USE THEREOF

(71) Applicant: SAINT-GOBAIN GLASS FRANCE, Courbevoie (FR)

(72) Inventors: Hans-Werner KUSTER, Aachen (DE); Walter SCHREIBER, Aachen (DE); Marc MAURER, Saint Jean aux Bois (FR)

(21) Appl. No.: 16/334,615

(22) PCT Filed: Jun. 26, 2017
(86) PCT No.: PCT/EP2017/065635

§ 371 Date: Mar. 19, 2019

(30) Foreign Application Priority Data
Sep. 20, 2016 (EP) 16189624.6

(51) Int. Cl. E06B 3/677; E06B 3/663; E06B 9/68; E06B 9/264

(52) U.S. Cl. CPC E06B 3/677; E06B 3/66314; E06B 2009/2643; E06B 9/68; E06B 9/264; E06B 3/66342

(57) ABSTRACT

An insulating glazing having a pressure-equalizing body, includes a first pane, a second pane, a peripheral spacer between the first pane and the second pane, wherein the spacer includes a hollow main body having at least two parallel pane contact walls, an outer wall, and a glazing interior wall and a bore opening through the outer wall and contains a desiccant arranged in the hollow main body. The hollow main body extends between the first and second panes along a periphery and, along this periphery, a partition wall extends through the hollow main body transversely to the periphery. An inner interpane space is formed between the first pane, the second pane, and the spacer, and a hollow pressure-equalizing body for pressure equalization between the inner interpane space and the surroundings of the insulating glazing. The pressure-equalizing body includes a surrounding outer wall and a gas-permeable membrane.

The invention relates to an insulating glazing and use thereof. An insulating glazing usually has a first pane and a second pane. A peripheral spacer is arranged between the first pane and the second pane. The spacer is implemented in the form of a hollow main body having at least two parallel pane contact walls, an outer wall, and a glazing interior wall.

Such insulating glazings can be implemented, relative to the surroundings, as hermetically sealed structures or as ventilated structures. Such insulating glazings are described, for example, in EP1356182A1 and in WO2014/095097A1.

Also known are insulating glazings that comprise a first pane, a second pane, and a blind that is arranged between the two panes. Such insulating glazings are described in DE10 2011 015983 A1 and JP S60 146195 U.

In the case of the hermetically sealed insulating glazing, there is the problem that the inner interpane space that is delimited by the first pane, the second pane, and the spacer changes as a function of the external barometric pressure. Consequently, the distance between the first pane and the second pane depends on the climatic conditions to which the insulating glazing is subjected during its service life. When, for example, the air pressure outside the insulating glazing rises, the first pane and the second pane are pressed together, and the inner interpane space is significantly restricted. When a blind is arranged in the inner interpane space, movement of the blind can be prevented and/or the blind damages the surfaces of the surrounding panes. Typical widths of inner interpane spaces with blinds incorporated therein start at approx. 27 mm and, consequently, enclose a significantly larger gas volume than insulating glass panes without internally arranged blinds.

In the case of a ventilated insulating glazing, there is the problem that water and/or water vapor can penetrate into the inner interpane space through the existing ventilation inlets. As a result, in the event of a sufficiently rapid drop in the outside temperature, the insulating glazing can fog from the inside. Stressful climatic conditions in the form of strong weather influences can thus reduce the service life of the insulating glazing.

The object of the invention consists in providing an insulating glazing that has an inner interpane space with a blind arranged therein, wherein the volume of the inner interpane space is subjected to no significant fluctuations even in the event of strong weather fluctuations or building-internal air pressure impacts and, at the same time, offers good protection against the penetration of moisture.

The object of the present invention is accomplished according to the invention by an insulating glazing in accordance with the independent claim 1. Preferred embodiments are apparent from the dependent claims.

The insulating glazing according to the invention comprises:
a first pane,
a second pane,
a peripheral spacer between the first pane and the second pane, wherein the spacer comprises a hollow main body having at least two parallel pane contact walls, an outer wall, and a glazing interior wall as well as a bore opening through the outer wall and contains a desiccant arranged in the hollow main body, wherein the hollow main body extends between the first pane and the second pane along a periphery and, along this periphery, at least one partition wall extends through the hollow main body transversely to the periphery, wherein an inner interpane space is formed between the first pane, the second pane, and the spacer, and
at least one hollow pressure-equalizing body for pressure equalization between the inner interpane space and the surroundings of the insulating glazing, wherein the pressure-equalizing body comprises a surrounding outer wall as well as a gas-permeable membrane fastened within the pressure-equalizing body and is connected to the spacer via the bore opening, wherein each pressure-equalizing body is arranged at a distance of less than 20% of the periphery of the hollow main body from a partition wall associated with the pressure-equalizing body,
   wherein the glazing interior wall, proceeding from the partition wall toward the pressure-equalizing body, is implemented with a region impermeable to water vapor and the impermeable region extends along at least 20%, preferably along at least 30%, and particularly preferably along at least 50% of the periphery of the hollow main body. Provision is made according to the invention that a blind is arranged in the inner interpane space, that the gas-permeable membrane is implemented as a water vapor barrier that has water vapor permeability of more than 50 g/(day m²) and less than 400 g/(day m²) measured in accordance with the method ASTM E96-10, and that the hollow main body is filled with desiccant along at least 80% of its entire periphery.

The pressure-equalizing body has a gas-permeable membrane and is, consequently, designed for the exchange of air between the interpane space and the surroundings of the insulating glazing. However, the membrane is, at the same time, designed as a water vapor barrier and thus limits entry of water vapor from the surroundings into the interpane space to the range of water vapor permeability indicated. This range ensures sufficiently rapid pressure equalization. The pressure equalization is sufficiently rapid if, within less than one minute, significant volume changes of the inner interpane space caused by pressure changes are equalized completely or enough that the remaining volume change is no longer significant. In the present case, significance is to be determined as follows. The minimum distance of blind slats from the surrounding glass panes is, with the insulating glass pane according to the invention, on each pane, preferably only 0.5 to 1 mm in each case. The gas exchange through the membrane occurs, in the event of usual weather-induced pressure fluctuations caused by temperature and/or air pressure changes, quickly enough that the minimum distance to the blind of 0.5 to 1 mm is maintained. When an extreme weather situation arises or strong pressure changes caused by building-housing technology occur suddenly, the pressure equalization is done so quickly by the membrane that the minimum blind distance range is restored within less than one minute.

In contrast to the pressure-equalizing body known from the prior art, the membrane with the water vapor permeabilities defined ensures a gas flow large enough that the pressure equalization for the inner pane volume necessarily enlarged by the blind is done sufficiently quickly, as described above.

The pressure equalization within the desiccant-filled spacer is done by the pressure-equalizing body. A gas, for example, a stream of air entering through the pressure-equalizing body, flows, by capillary action of the desiccant-filled spacer, initially along the impermeable region. Here, the stream of air passes the previously introduced desiccant in the hollow main body whereas, at the same time, an exchange of air between these regions of the hollow main body and the inner interpane space of the glazing is prevented. Thus, the stream of air is initially pre-dried in the impermeable region of the spacer. It can then enter the inner interpane space of the insulating glazing through a subsequent permeable region following the impermeable region. The stream of air is then already pre-dried such that penetration of moisture into the inner interpane space is prevented or reduced. Because of the gas-permeable membrane, which has water vapor permeability in the specified range, it is necessary to arrange more desiccant than usual in the hollow main body. This hollow main body is filled along at least 80% of its entire periphery. Customary filling quantities of insulating glazings do not exceed 50% of the entire periphery.

By means of these measures, the long-term stability as well as the insulating effect of the insulating glazing with an internally arranged blind can be further improved, resulting in a longer service life of the insulating glazing. Furthermore, the insulating glazing complies with the standards regarding a dewpoint reduction to −30° C. within 24 h after production. The insulating glazing is distinguished by longevity that can exceed the customary 10-year warranty.

Selected as materials for the first pane and the second pane, which are preferably transparent, are, for example, materials from the group consisting of colored and uncolored glasses, colored and uncolored, rigid, clear plastics that are provided with a barrier layer against vapor diffusion. Preferably selected, however, are colored and uncolored glasses. The colored and uncolored glass is preferably selected from the group consisting of colored and uncolored, non-tempered, partially tempered, and tempered float glass, cast glass, ceramic glass, and glass. Float glass is particularly preferred.

The hollow main body extends between the first pane and the second pane along a periphery. Along this periphery, at least one partition wall extends through the hollow main body transversely to the periphery. In other words, the partition wall is arranged in the hollow main body such that it constitutes a separating element that hermetically separates adjacent regions of the hollow main body from one another. The partition wall is implemented full surface and without openings such that, even microscopically, no contact, communication, or connection capability is possible between the regions separated thereby. Preferably, the partition wall is arranged adjacent an impermeable region and adjacent a permeable region of the glazing interior wall of the hollow main body such that it separates, in a gas-tight manner, a section of the hollow main body with the impermeable region from another section of of the hollow main body with the permeable region.

The at least one hollow pressure-equalizing body, which comprises a surrounding outer wall as well as a gas-permeable membrane fastened within the pressure-equalizing body, is connected to the spacer via the bore opening. Preferably, this is a sealed connection that is preferably realized with a separate sealing means. A sealing means, for example, butyl (polyisobutylene/PIB) closes, for example, the gap between the outer wall of the pressure-equalizing body with the spacer in an airtight manner. Alternatively, the outer wall of the pressure-equalizing body can be constructed from a material with sealing properties or with a coating of such a material. Due to the gas-tight insulation layer, a gas exchange with the atmosphere is possible only via the pressure-equalizing body. In this manner, a defined pressure and temperature equalization between the insulating glazing and the surroundings is possible. The sealing means, in particular butyl, improves the seal and strength of the pressure-equalizing body.

Each pressure-equalizing body is arranged at a distance of less than 20% of the periphery of the hollow main body from a partition wall associated with the pressure-equalizing body. As a result, the pressure-equalizing body is arranged adjacent its partition wall associated therewith. The glazing interior wall is, proceeding from the partition wall toward the pressure-equalizing body, implemented with an impermeable region; and the partition wall preferably separates the impermeable region of the glazing interior wall from a permeable region of the glazing interior wall. As a result of this structure, pressure equalization between the inner and the outer interpane space is ensured; however, gas, such as air, entering through the pressure-equalizing body into the hollow main body of the spacer is forced, before entry into the inner interpane space, to move through the desiccant-filled hollow main body so long as it is forced to move along the impermeable region of the glazing interior wall.

The statement that the hollow main body is filled with desiccant along at least 80% of its entire periphery means that the filling of the hollow main body is at least 80%, regardless of whether air inclusions are present or not among a granular desiccant. Such air inclusions do not reduce the above percentage of filling and are ignored in the indication of the filling. The statement is not meant microscopically, but rather macroscopically and is based in particular in percentage terms on a filling of the hollow space of the hollow main body along its direction of extension, with the desiccant to be considered, despite possible air inclusions, as mass without taking the air inclusions into account.

All hollow body profiles known according to the prior art can be used as the main body regardless of their material composition. Polymeric or metallic main bodies are mentioned here by way of example.

Polymeric main bodies preferably contain polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), particularly preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Polymeric main bodies can optionally also contain other constituents, for example, glass fibers and/or hollow glass beads. The polymeric materials used are usually gas permeable such that if this permeability is undesirable, additional measures must be taken.

Metallic main bodies are preferably made of aluminum or stainless steel and have no gas permeability.

The main body has a hollow chamber. The hollow chamber is delimited by the at least two parallel pane contact walls, the outer wall, and the glazing interior wall and, viewed along its periphery, is filled with desiccant at least to 80% of its extension. Customarily, the hollow chambers of the main bodies are filled along their periphery with desiccant not to at least 80% but significantly less in the range from 20 to 40%. In particular, the implementation of an insulating glass window with an internal blind requires a greater distance between the two panes such that the air volume of the pane interior to be kept dry over the service life is likewise larger. With the use of a pressure-equalizing body that permits the inflow and outflow of air into the pane interior, it is, consequently, necessary to have a greater capacity of desiccant available. The main body can be circular or elliptical in cross-section; however, it is preferably rectangular.

In an advantageous embodiment, the walls of the main body are gas permeable. Regions of the main body in which such permeability is undesirable, such as, the impermeable region of the glazing interior wall and the outer wall of the hollow main body can, for example, be sealed with a gas-tight insulation layer. Particularly in the case of a polymeric main body, a first gas-tight insulation layer is provided on the outer wall; and a second gas-tight insulation layer, on the glazing interior wall to implement the impermeable region.

In another preferred embodiment, the main body is gas impermeable, wherein permeability can be obtained, for example, by introduction of openings. Particularly, in the case of metallic main bodies whose wall is not gas permeable, openings are introduced where necessary in order to obtain gas permeability. For example, to produce the permeable region of the glazing interior wall, openings are introduced in this region of the glazing interior wall in the required number and size. The total number of the openings depends on the size of the insulating glazing. The openings connect the the hollow chambers of the spacer to the inner interpane space of the insulating glazing, as a result of which a gas exchange between them becomes possible. The openings are preferably implemented such that the desiccant arranged in the hollow chamber cannot enter the inner interpane space. The openings are preferably implemented as slots, particularly preferably as slots with a width of 0.2 mm and a length of 2 mm.

The insulating glazing according to the invention further includes a hollow pressure-equalizing body with the gas-permeable membrane fastened therein. The pressure-equalizing body thus has no movable parts and is thus not subject to any mechanical wear during the service life of the insulating glass pane. An outer wall of the pressure-equalizing body can be implemented as a cylindrical surface or or as a surface connected via edges and thus forms the sleeve of the hollow pressure-equalizing body. The gas-permeable membrane is fastened in the hollow pressure-equalizing body such that the gas exchange within the pressure-equalizing body must take place via the membrane. The membrane is designed such that gases, preferably gases of the air, can pass through the membrane and water vapor is retained. The membrane implemented as a water vapor barrier has water vapor permeability of more than 50 g/(day m²) and less than 400 g/(day m²) measured in accordance with the method ASTM E96-10. The membrane preferably has water vapor permeability measured in accordance with the method ASTM E96-10 of more than 70 g/(day m2) and less than 350 g/(day m²), more preferably of more than 100 g/(day m²) and less than 300 g/(day m²), even more preferably of more than 120 g/(day m²) and less than 250 g/(day m²). The pressure-equalizing body is preferably arranged in an outer interpane space between the first pane and the second pane. Preferably, a sealing compound is also arranged in the outer interpane space between the first pane and the second pane. The sealing compound fills the outer interpane space and surrounds the pressure-equalizing body and protects it against mechanical action from the outside in this manner.

The insulating glazing according to the invention having a pressure-equalizing body is an open system, wherein the pressure-equalizing body contains no valve and no movable parts. Pressure equalizing valves have the disadvantage that only a specific volume can be exchanged and, in the case of large panes, multiple valves are necessary. The pressure-equalizing body installed according to the invention is, in contrast, economical and can be integrated into any hollow profile spacers. In a preferred embodiment, the pressure-equalizing body includes a sleeve as an outer wall and a membrane introduced therein; particularly preferably, the pressure-equalizing body comprises these two components. The sleeve serves to fix the membrane in a suitable position. The sleeve is gas impermeable such that an air exchange can occur only via the membrane. Since the pressure-equalizing body according to the invention is non-mechanical, it has an extremely long service life.

The pressure-equalizing body is connected to the spacer via a bore opening optionally through the aforementioned insulation layer and through the outer wall. A sealing means, for example, butyl (polyisobutylene/PIB) closes the gap between the outer wall of the pressure-equalizing body with the spacer in an airtight manner. A gas exchange with the atmosphere is possible only via the pressure-equalizing body. In this manner, a defined pressure and temperature equalization between the insulating glazing and the surroundings is possible. The sealing means, in particular butyl, improves the sealing and the strength of the pressure-equalizing body.

The hollow main body contains a desiccant, preferably silica gel, CaCl₂), Na₂SO₄, activated carbon, silicates, bentonites, zeolites, and/or mixtures thereof, particularly preferably molecular sieves. This desiccant is introduced into the hollow chamber of the main body. Thus, absorption of atmospheric moisture by the desiccant is allowed and penetration of moisture into the inner interpane space and fogging of the panes are prevented or reduced.

The hollow main body has one or a plurality of partition walls. The partition walls limit the direct gas flow through the hollow main body. The partition walls enable a variation of the main body space that makes direct contact with the pressure-equalizing body.

The main body has a partition wall that is arranged adjacent the pressure-equalizing body. A gas exchange through the partition wall is impossible such that a gas flow through the pressure-equalizing body can pass through the main body only in one direction. In a preferred embodiment, the insulating glazing has two pressure-equalizing bodies, with each pressure-equalizing body associated in each case with one partition wall. In the case of a rectangular main body that has two longitudinal sides and two transverse sides, one pressure-equalizing body is preferably arranged on one longitudinal side and the other pressure-equalizing body is arranged on the other longitudinal side; or, alternatively, one pressure-equalizing body is preferably arranged on one transverse side and the other pressure-equalizing body is arranged on the other transverse side. The associated partition walls are arranged accordingly.

The glazing interior wall of the spacer includes a permeable region that gas-permeably connects the hollow chamber of the main body to the inner interpane space of the insulating glazing. Thus, an exchange of air is possible between these two gas spaces.

The glazing interior surface further has the impermeable region that is impermeable to gas and which separates and insulates the inner interpane space of the insulating glazing from the hollow chamber of the main body. In one possible embodiment, the second gas-tight insulation layer is mounted on the glazing interior wall in this impermeable region. In another advantageous embodiment, the glazing interior wall has a gas-tight wall.

The pressure-equalizing body is arranged in the outer wall, which is gas-tight, opposite the impermeable region of the glazing interior wall. The pressure-equalizing body is mounted adjacent the partition wall, and the glazing interior wall situated in the region of the pressure-equalizing body and the partition wall is likewise gas-impermeable. The impermeable region extends along at least 20%, preferably along at least 30%, and particularly preferably along at least 50% of the periphery of the hollow main body, before a permeable region connects to the impermeable region. A stream of air entering through the pressure-equalizing body thus flows along the impermeable region of the spacer and then enters into the inner interpane space of insulating glazing in the following permeable region. In the process, the stream of air passes the desiccant introduced into the hollow chamber of the spacer. An exchange of air between the hollow chamber and the inner interpane space of the insulating glazing is prevented within the impermeable region of the spacer. Thus, the stream of air is first pre-dried in the impermeable region of the spacer before it enters into the inner interpane space. Thus, the long-term stability as well as the insulating effect can be further improved, as a result of which a longer service life of the insulating glazing is achieved. In the production of insulating glazings, according to industry standards, a dewpoint reduction to −30° C. is to be reached already 24 hours after production such that the product can already be delivered shortly after production.

The length d of the impermeable region, measured along the peripheral spacer is at least 0.2 U, where U is the perimeter of the spacer along the glazing interior wall. Preferably, d>0.3 U, particularly preferably d>0.5 U. As a result, the drying path of the stream of air is enlarged in the impermeable region such that the long-term stability, insulating effect, and service life of the glazing are further optimized. At the same time, the desiccant present along at least 0.8 U of the spacer offers a reservoir to keep the pane interior sufficiently dry.

For selective control of the gas flow through the main body, a plurality of alternating permeable regions and impermeable regions can be introduced into the glazing interior wall. The permeable region and the impermeable region are then segmented in each case. In a preferred embodiment, one impermeable region and one permeable region are present, wherein the impermeable region borders on the pressure-equalizing body. In an alternative preferred embodiment, two impermeable regions and two permeable regions are present, wherein the impermeable regions adjoin in each case a pressure-equalizing body.

In the case of a gas-permeable implementation of the hollow main body, the outer wall comprises a first gas-tight insulation layer. The glazing interior wall comprises, partially or in sections, the second gas-tight insulation layer when the hollow main body of the spacer is gas-permeable. In this manner, the gas flow within the gas-permeable body can be pre-adjusted, controlled, and regulated. In the context of the invention, the expression “second gas-tight insulation layer” also includes a section of the glazing interior wall that is not gas-permeable. Preferably, at least 30%, particularly preferably at least 50% of the glazing interior wall is covered or coated with the second gas-tight insulation layer. This region of the glazing interior wall coated with the gas-tight insulation layer forms the impermeable region. This can, for example, also be realized alternatively by a non-perforated impermeable region of the glazing interior wall.

In a possible embodiment, the first gas-tight insulation layer and/or the second gas-tight insulation layer contains iron, aluminum, silver, copper, gold, chromium, and/or alloys or mixtures thereof. The metallic layer preferably has a thickness of 10 nm to 200 nm.

The hollow pressure-equalizing body is preferably connected to the bore opening via a narrowing. The narrowing facilitates the insertion of the pressure-equalizing body into the bore opening and improves the sealing action of the sealing compound and/or of the sealing means, for example, a butyl cord.

The sealing compound preferably contains organic polysulfides, silicones, RTV (room-temperature vulcanizing) silicone rubber, HTV (high-temperature vulcanizing) silicone rubber, peroxide vulcanizing silicone rubber, and/or addition-vulcanizing silicone rubber, polyurethanes, butyl rubber, and/or polyacrylates. In an optional embodiment, additives for increasing aging resistance, for example, UV stabilizers can also be contained.

In a preferred embodiment, the sleeve (outer wall) of the pressure-equalizing body includes metals or gas-tight plastics, preferably aluminum, polyethylene vinyl alcohol (EVOH), low density polyethylene (LDPE), and/or biaxially oriented polypropylene film (BOPP), particularly preferably polyethylene vinyl alcohol.

In an alternative embodiment, the sleeve (outer wall) of the pressure-equalizing body preferably contains elastomers, preferably rubber, particularly preferably vulcanized polyisoprene, RTV (room-temperature vulcanizing) silicone rubber, HTV (high-temperature vulcanizing) silicone rubber, peroxide vulcanizing silicone rubber, and/or addition vulcanizing silicone rubber, butyl rubber, and/or mixtures thereof.

The sealing compound preferably includes butyl (polyisobutylene (PIB)), preferably as a butyl cord. Butyl enables long-term stable and readily shapeable sealing of the intermediate space between the pressure-equalizing body and the spacer.

In a preferred embodiment, the hollow main body is filled with desiccant along at least 84%, preferably at least 87%, of its entire periphery. Thus, the penetration of moisture into the inner interpane space can be prevented long term, even when relatively large pane interior volumes are present with distances between the panes of more than 2 or 3 cm are present.

Preferably, the pressure-equalizing body is arranged in an outer interpane space between the first pane and the second pane. The pressure-equalizing body is thus protected laterally by the panes, in particular during installation of the insulating glazing in and/or on a window frame. Preferably, a sealing compound is additionally arranged around the pressure-equalizing body in the outer interpane space between the first pane and the second pane such that mechanical effects on the pressure-equalizing body on all sides are precluded.

In a preferred embodiment, the pressure-equalizing body is arranged in the upper third of the insulating glazing, based on the operational installation position on and/or in a window frame. If water should penetrate from below into the window frame of the insulating glazing and collect on the spacer from the outside, the pressure equalization in the upper region of the insulating glass pane is nevertheless still ensured.

Preferably, the pressure-equalizing body is arranged in a vertical region of the insulating glazing, based on the operational installation position on and/or in a window frame. Thus, penetration of moisture into the insulating glazing can be further prevented or reduced.

In a preferred embodiment, two pressure-equalizing bodies are arranged in the vertical region of the insulating glazing, in the upper third of the insulating glazing in each case, based on the operational installation position on and/or in a window frame. Preferably, one pressure-equalizing body is arranged on a vertically disposed outer wall of the spacer in the upper third, and the other pressure-equalizing body is arranged in another vertically disposed outer wall of the spacer in the upper third.

In a preferred embodiment, the inner interpane space delimited by the first pane, the second pane, and the glazing interior wall of the spacer is air-filled. The inner interpane space is not hermetically sealed but, instead, is gas accessible through the combination of the permeable region of the glazing interior wall, the hollow main body, and the pressure-equalizing body arranged in the outer wall. An air-filled inner interpane space has advantages compared to a protective-gas filled, for example, noble-gas filled inner interpane space: Even small leaks within the spacer can easily lead, during the service life of an insulating glass window filled with protective gas, to the loss of the protective gas between the insulating glazings. Apart from a poorer insulating effect, it can also happen that moisture can penetrate into the insulating glazing. Condensation formed by moisture between the panes of the insulating glazing thus quite substantially worsens the optical quality and, in many cases, makes replacement of the entire insulating glazing necessary. However, at the same time, a very tightly sealed insulating glazing is susceptible to fluctuations of air pressure or temperature. Large pressure differences are also linked to large temperature fluctuations, for example, with changing sunlight. These pressure differences can result in deformations of the insulating glazing itself but also of the frame. These deformations adversely affect the service life and the leakproofness of the adhesive bond between the first and the second pane and the spacer. For these reasons, a combination of an almost completely desiccant-filled spacer with an air-filled inner interpane space is advantageous. Fluctuations of air pressure or temperature as well as atmospheric moisture affect the insulating glazing according to the invention little or not at all.

A blind is arranged in the inner interpane space. An advantage of the arrangement of the blind in the inner interpane space of an insulating glazing is that it is arranged there in a protected manner. It does not get dirty. In addition, its mechanical vulnerability is low. An advantage of an insulating glazing with an interpane blind compared, for example, to insulating glazings with surface deposition consists in that, with an insulating glazing with a blind arranged in the inner interpane space, light permeability and total solar energy permeability can be optimally adapted in a variable manner at any time to changeable conditions and, moreover, an additional variable privacy screen is provided.

The operation of the blind can be mechanical or/and electrical by a user or even semi- or fully automatic by commercially available control and regulating devices. The insulating glazing is preferably implemented such that the blind is adjustable in a closed and open position and intermediate positions. For this, at least one mechanical drive and/or at least one electrical drive for the blind can be provided, preferably in combination with a control circuit provided for the control of the at least one mechanical or electrical drive, which can be activated at least by manual operating settings and/or by signals of at least one sensor. For this purpose, the panes are equipped with suitable external connectors that are preferably arranged adjacent the pressure-equalizing body. The insulating glazing can also have a top box, which is arranged, in the operational installation position of the insulating glazing, in the upper third of the inner interpane space and is implemented to house the blind in the closed position and/or the drive for the blind.

The blind can be a blind of any known type. For example, it is a slatted blind. The blind can be provided with solar protection. The slats are preferably at least partially provided with a coating that affects visible light and/or reflects heat. Preferably, the slatted blind has at least a coating for increasing the reflection of visible and/or infrared light. Preferably, in the operational installation position of the insulating glazing, the coating to increase the reflection of visible and/or infrared light is not arranged on the room side, but rather on the outside. The expressions “room side” and “outside” mean an orientation of the blinds in their operational installation position, whose sides facing the first or the second pane are arranged facing a room or away from a room, i.e., toward the outside, or facing an environment surrounding a building. Preferably, the slats have, at least on the room side, a protective layer with high infrared permeability. Furthermore, the blind can have a layer, in particular in the form of a coating or metallization with relatively low emissivity in the infrared range that is arranged on the room side or the outside, by means of which high thermal insulation can be ensured along with high light transmittance.

Preferably, the blind can be actuated electrically or mechanically. Compared to a blind that is arranged in a hermetically sealed inner interpane space and that usually has to have a width of 22 mm or less extending parallel to the above distance with a customary distance between the first and the second pane of 27 mm after production of the insulating glazing, since the panes, when subjected to climatic changes and associated pressure changes in the inner interpane space, have an interpane distance of less than 27 mm and thus, can mechanically damage the blind and/or the inner surfaces of the panes during movement of the blind, the insulating glazing according to the invention can, due to the pressure-equalizing body provided, have a blind with a width of more than 22 mm with an interpane distance of 27 mm. Preferably, the blind of the insulating glazing according to the invention has a width in the range from 23 to 26 mm preferably 24 to 25 mm with an interpane distance of 27 mm. When the width of the blind is significantly smaller than the interpane distance, the reduced width of the blind results in a larger number of blind slats, which is disadvantageous for the shading functionality of the blind elements and for the installation height. With the insulating glazing according to the invention, the width of the blind is preferably only 1 to 2 mm less than the distance between the first pane and the second pane. This opens up new possibilities for shading as well as for light deflection.

In a preferred embodiment, the blind is connected to and operable by a magnetic coupling. This enables mechanical actuation of the blind by magnetic transmission. One advantage here is that no cable that has to be routed through the spacer is required.

In an alternative preferred embodiment, the blind is connected to and operable by an electric motor. For electrical actuation, the electric motor is preferably installed in the inner interpane space, and a cable is routed through the spacer into the outer interpane space. However, alternatively, the electric motor can also be arranged in the outer interpane space, and a cable can be routed through the spacer into the inner interpane space.

Preferably, the electric motor arranged in the inner interpane space is connected to a cable that passes out of the inner interpane space through a permeable region of the glazing interior wall into the hollow main body and is routed in the hollow main body from the permeable region to the impermeable region and and is routed out of the hollow main body through the outer wall in the region of the impermeable region. As a result, the cable is routed out of the outer wall at a point that is distant from the permeable region of the glazing interior wall. In other words, if water and/or water vapor should pass through a bore opening provided for the cable, it is deflected along the desiccant arranged in the hollow main body and can be absorbed thereby before entry into the inner interpane space. The cable is advantageously guided through the hollow main body along at least 50% of the length of the impermeable region of the hollow main body and preferably along at least 75%, of the length of the impermeable region of the hollow main body.

Preferably, the cable is routed into the spacer in the outer wall adjacent the pressure-equalizing body. In other words, the cable and the pressure-equalizing body are routed through the outer wall of the spacer through the same bore opening in the outer wall. In addition to a cost advantage, this embodiment offers the advantage that possibilities for penetration of water and/or water vapor through the outer wall are kept low.

As already mentioned, the combination of the pressure-equalizing body without movable components with a spacer almost completely filled with desiccant and the forced guidance of pressure equalizing gas flows through the impermeable regions offers the possibility of keeping larger pane interior volumes sufficiently free of moisture throughout the service life of the insulating glazing. Advantageously, the two panes of the insulating glazing are arranged at a distance of at least 25 mm, preferably of at least 30 mm, and particularly preferably of at least 40 mm.

The invention further comprises the use of the insulating glazing according to the invention as building interior glazing, building outer glazing, and/or façade glazing.

In the following, the invention is explained in detail with reference to drawings. The drawings are purely schematic representations and, consequently, not to scale. They in no way restrict the invention. The drawings depict in:

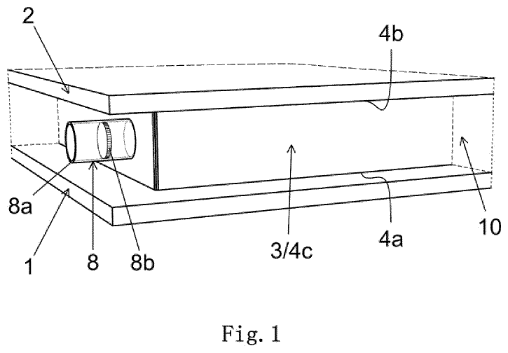

FIG. 1 a schematic partial side view of the insulating glazing according to the invention;

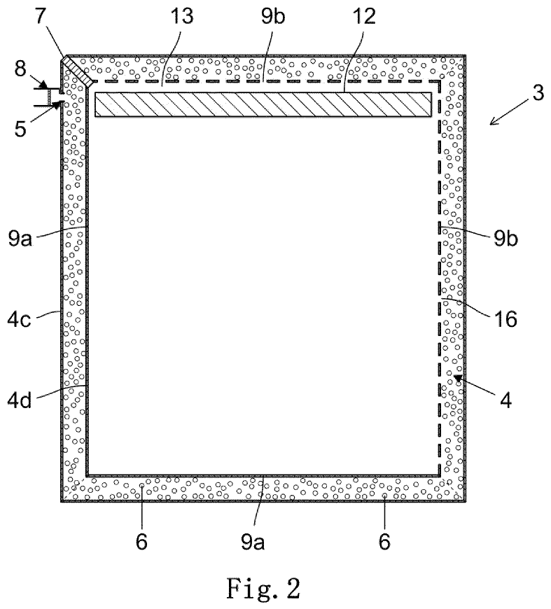

FIG. 2 a schematic view of the entire periphery of a spacer of an insulating glazing according to the invention;

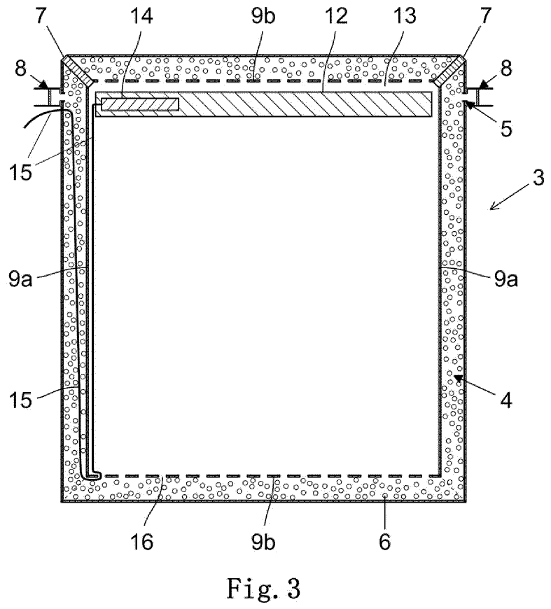

FIG. 3 a schematic view of the entire periphery of another spacer of another insulating glazing according to the invention; and

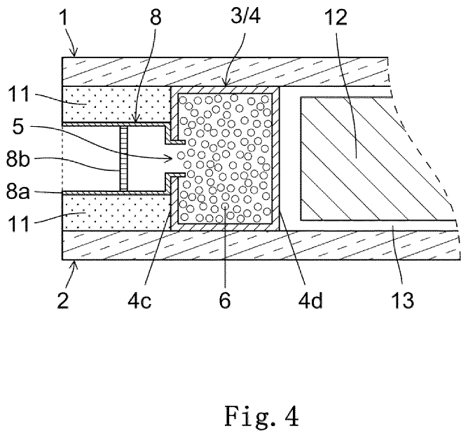

FIG. 4 a cross-section of an edge region of an insulating glazing according to the invention with a pressure-equalizing body.

FIG. 1 depicts a schematic partial side view of the insulating glazing according to the invention. Arranged between a first pane 1 and a second pane 2 is a spacer 3 that has a hollow main body, whose outer wall 4c is discernible. The hollow main body further has a pane contact wall 4a facing the first pane 1, a pane contact wall 4b facing the second pane 2, and a glazing interior wall (not shown). The spacer 3 is connected to a pressure-equalizing body 8 that is arranged in an outer interpane space 10 that is situated between the first pane 1 and the second pane 2. The outer interpane space 10 is filled with a sealing compound (not shown). The pressure-equalizing body 8 is hollow and has an outer wall 8a and, in the interior, a gas-permeable membrane 8b. The gas-permeable membrane 8b is implemented as a water vapor barrier that has water vapor permeability of more than 50 g/(day m²) and less than 400 g/(day m²) measured in accordance with the method ASTM E96-10.

FIG. 2 depicts a schematic view of a spacer of an insulating glazing according to the invention, as depicted, for example, in FIG. 1. The view depicts the spacer 3 in cross-section in the operational installation position of the insulating glazing in and/or an a window frame (not shown). The spacer 3 has the hollow main body 4 that is rectangular.

The hollow main body 4 is completely filled with desiccant 6 along its periphery. It is formed from the pane contact wall (not shown) facing the first pane (not shown), the pane contact wall (not shown) facing the second pane (not shown), the outer wall 4c, and the glazing interior wall 4d. The pressure equalization within the spacer 3 filled with desiccant 6 is done by the pressure-equalizing body 8, which is arranged on the outer wall 4c in the upper third in the vertical region of the spacer 3. The outer wall 4c has, for this purpose, a bore opening 5, through which the pressure-equalizing body 8 is connected to the spacer 3. Arranged at a distance of less than 20% of the periphery of the hollow main body 4 is a partition wall 7 associated with the pressure-equalizing body 8, which partition wall 7 extends through the hollow main body 4 transversely to the periphery. The glazing interior wall 4d is implemented with an impermeable region 9a, proceeding from the partition wall 7 toward the pressure-equalizing body 8. The impermeable region 9a extends along 50% of the periphery of the hollow main body 4. Also, the glazing interior wall 4d has, proceeding from the partition wall 7 in the direction facing away from the pressure-equalizing body 8, a permeable region 9b, which also extends along 50% of the periphery of the hollow main body 4. The first pane (not shown), the second pane (not shown), and the glazing interior wall 4d of the spacer 3 delimit an inner interpane space 13. Arranged in the inner interpane space 13 is a blind 12, which is adjustable from a closed position, which is depicted, into an open position and positions therebetween. Optionally, the blind is housed in a top box (not shown) in the closed position. The position of the blind 12 can be changed by means of a drive (not shown), for example, a magnetic coupling.

The hollow main body 4 is outwardly gas-tight everywhere except for the built-in pressure-equalizing body 8. The partition wall 7 is likewise implemented gas-tight. The permeable region 9b of the glazing interior wall 4d has openings 16 that are introduced into the glazing interior wall 4d such that, in this region, they enable a gas exchange between the hollow main body 4 and the inner interpane space 13. The openings 16 are formed as slots with a width of 0.2 mm and a length of 2 mm. The slots ensure an optimum air exchange without desiccant being able to penetrate out of the hollow main body 4 into the inner interpane space 13 of the glazing. Preferably, the hollow main body 4 is made of a gas-permeable material, with the impermeable region 9a of the glazing interior wall 4d and the outer wall 4c being provided with gas-impermeable insulating films or thin layers (not shown).

The pressure equalization within the spacer 3 filled with desiccant 6 is done, as already described, by the pressure-equalizing body 8. A stream of air entering through the pressure-equalizing body 8 flows by capillary action of the spacer 3 filled with desiccant 6 first along the impermeable region 9a. The stream of air passes the desiccant 6 introduced into the hollow main body of the spacer 3, while, at the same time, an air exchange between the hollow main body 4 and the inner interpane space 13 of the insulating glazing is prevented. Thus, the stream of air is first pre-dried in the impermeable region 9a of the spacer 3 before it then enters, in the following permeable region 9b, into the inner interpane space 13 of the insulating glazing. Thus, the long-term stability as well as the insulating effect can be further improved, as a result of which a longer service life of the glazing is achieved. Moreover, the insulating glazing conforms to the standards relative to a reduction in dewpoint to −30° C. within 24 h after production.

FIG. 3 depicts a schematic view of another spacer of another insulating glazing according to the invention. The spacer 3 depicted in FIG. 3 corresponds to the spacer depicted in FIG. 2 with the difference that it has a further pressure-equalizing body 8 and a further partition wall 7 associated with this pressure-equalizing body 8, a segmented impermeable region 9a, a segmented impermeable region 9b, and a further bore opening 5. The view depicts the spacer 3 in the operational installation position of the insulating glazing in and/or on a window frame (not shown). The spacer 3 has the hollow main body 4 that is rectangular and is completely filled with desiccant 6 along its periphery. The hollow main body 4 is formed from the pane contact wall (not shown) facing the first pane (not shown), the pane contact wall (not shown) facing the second pane (not shown), the outer wall 4c, and the glazing interior wall 4d. The pressure equalization within the spacer 3 filled with desiccant 6 is done by the two pressure-equalizing bodies 8, which are in each case arranged in the upper third in the vertical region of the spacer 3 on the outer wall 4c. The outer wall 4c has two bore openings 5, through which the pressure-equalizing bodies 8 are each case connected to the spacer 3. Arranged at a distance of less than 20% of the periphery of the hollow main body 4 is in each case a partition wall 7 associated with the pressure-equalizing body 8, which extends through the hollow main body 4 transversely to the periphery in a gas-tight manner. The glazing interior wall 4d is implemented with an impermeable region 9a, proceeding from the respective partition wall 7 toward the pressure-equalizing body 8. The impermeable region 9a extends, in all, along 50% of the periphery of the hollow main body 4 but is segmented into two opposite sections. Moreover, the glazing interior wall 4d has, in each case proceeding from the partition wall 7 in the direction facing away from the pressure-equalizing body 8, a segmented permeable region 9b, which extends, in all, along 50% of the periphery of the hollow main body 4. The impermeable region 9a and the permeable region 9b have in each case two segments. The segments of the impermeable region 9a and of the permeable region 9b are alternatingly arranged. The glazing interior wall 4d is implemented along longitudinal sides of the rectangular hollow main body 4 as impermeable region 9a; whereas along transverse sides of the rectangular hollow main body 4, it is implemented as permeable region 9b.

Also, depicted in FIG. 3 is a drive for the blind 12 situated in the inner interpane space. The drive has an electric motor 14 that is arranged in the inner interpane space 13. The electric motor 14 is connected to a cable 15 that passes out of the inner interpane space 13 through a permeable region 9b of the glazing interior wall 4d into the hollow main body 4 and is routed in the hollow main body 4 from the permeable region 9b to the impermeable region 9a and is guided out in the region of the impermeable region 9a through the outer wall 4c out of hollow main body 4. The cable 15 is routed in the outer wall 4c adjacent the one pressure-equalizing body 8 in the spacer 3 via the bore opening 5. Such a drive can also be used in the spacer depicted in FIG. 2.

The pressure equalization within the spacer 3 filled with desiccant 6 is done, as already described in connection with FIG. 2, by the pressure-equalizing body 8. If the routing of the cable 15 through the outer wall 4c is is not to be airtight, a stream of air entering it flows by capillary action of the spacer 3 filled with desiccant 6 first along the impermeable region 9a. The stream of air passes the desiccant 6 that was introduced into the hollow main body 4 of the spacer 3; whereas, at the same time, an exchange of air between the hollow main body 4 and the inner interpane space 13 of the insulating glazing is prevented. Thus, the stream of air is first pre-dried in the impermeable region 9a of the spacer 3 before it then enters into the inner interpane space 13 of the insulating glazing in the following permeable region 9b. By means of this routing of the cable 15, the long-term stability as well as the insulating effect can be further improved, as a result of which a longer service life of the insulating glazing is achieved.

FIG. 4 depicts a cross-section of an edge region of an insulating glazing according to the invention, which is depicted, for example, in FIG. 2 or FIG. 3. Arranged between the first pane 1 and the second pane 2 is the spacer 3 having the hollow main body 4, of which an outer wall 4c and a glazing interior wall 4d are depicted. An outer interpane space (not shown) between the first pane 1 and the second pane 2 is filled with a sealing compound 11, for example, organic polysulfide. The hollow pressure-equalizing body 8 is connected to the spacer 3 via the bore opening 5 in the outer wall 4c. The pressure-equalizing body 8 has an outer wall 8a and a gas-permeable membrane 8b, which is implemented as a water vapor barrier that has water vapor permeability of more than 50 g/(day m²) and less than 400 g/(day m²) measured in accordance with the method ASTM E96-10. The blind 12 is arranged in the inner interpane space 13, which is delimited by the first pane 1, the second pane 2, and the glazing interior wall 4d.

### LIST OF REFERENCE CHARACTERS

1 first pane
2 second pane
3 spacer
4 main body
4a pane contact wall
4b pane contact wall
4c outer wall
4d glazing interior wall
5 bore opening
6 desiccant
7 partition wall
8 pressure-equalizing body
8a outer wall
8b gas-permeable membrane
9a impermeable region
9b permeable region
10 outer interpane space
11 sealing compound
12 blind
13 inner interpane space
14 electric motor
15 cable
16 opening

1. An insulating glazing having a pressure-equalizing body, comprising:
a first pane;
a second pane;
a peripheral spacer between the first pane and the second pane, wherein the peripheral spacer comprises a hollow main body having at least two parallel pane contact walls, an outer wall, and a glazing interior wall as well as a bore opening through the outer wall and contains a desiccant arranged in the hollow main body, wherein the hollow main body extends between the first pane and the second pane along a periphery and, along said periphery, at least one partition wall extends through the hollow main body transversely to the periphery, wherein an inner interpane space is formed between the first pane, the second pane and the spacer, and
at least one hollow pressure-equalizing body for pressure equalization between the inner interpane space and the surroundings of the insulating glazing, wherein the pressure-equalizing body comprises a surrounding outer wall as well as a gas-permeable membrane fastened within the pressure-equalizing body and is connected to the peripheral spacer via the bore opening, wherein each pressure-equalizing body is arranged at a distance of less than 20% of the periphery of the hollow main body from a partition wall associated with the pressure-equalizing body,
wherein the glazing interior wall, proceeding from the partition wall toward the pressure-equalizing body, is implemented with a region impermeable to water vapor and the impermeable region extends along at least 20% of the periphery of the hollow main body, wherein
a blind is arranged in the inner interpane space,
wherein the membrane is implemented as a water vapor barrier that has water vapor permeability of more than 50 g/(day m²) and less than 400 g/(day m²) measured in accordance with the method ASTM E96-10, and wherein the hollow main body is filled with desiccant along at least 80% of its entire periphery.

2. The insulating glazing according to claim 1, wherein the hollow main body is filled with desiccant along at least 84% of its entire periphery.

3. The insulating glazing according to claim 1, wherein the pressure-equalizing body is arranged in an outer interpane space between the first pane and the second pane.

4. The insulating glazing according to claim 3, wherein a sealing compound is arranged around the pressure-equalizing body in the outer interpane space between the first pane and the second pane.

5. The insulating glazing according to claim 1, wherein the pressure-equalizing body is arranged in the upper third of the insulating glazing, based on the operational installation position on and/or in a window frame.

6. The insulating glazing according to claim 1, wherein the pressure-equalizing body is arranged in a vertical region of the insulating glazing, based on the operational installation position on and/or in a window frame.

7. The insulating glazing according to claim 1, wherein an inner interpane space delimited by the first pane, the second pane, and the glazing interior wall of the peripheral spacer is filled with air.

8. The insulating glazing according to claim 1, wherein the gas-permeable membrane implemented as a water vapor barrier has water vapor permeability measured in accordance with the method ASTM E96-10 of more than 70 g/(day m²) and less than 350 g/(day m²).

9. The insulating glazing according to claim 1, wherein the blind is connected to and can be operated with a magnetic coupling.

10. The insulating glazing according to claim 1, wherein the blind is connected to and can be operated with an electric motor.

11. The insulating glazing according to claim 10, wherein the electric motor is connected to a cable that passes out of the inner interpane space through a permeable region of the glazing interior wall into the hollow main body and is routed in the hollow main body from the permeable region to the impermeable region, and is routed out of the hollow main body through the outer wall in the region of the impermeable region.

12. The insulating glazing according to claim 11, wherein the cable is routed along at least 50% of the length of the region of the hollow main body impermeable to water vapor through the hollow main body.

13. The insulating glazing according to claim 11, wherein the cable is routed into the peripheral spacer in the outer wall adjacent the pressure-equalizing body.

14. The insulating glazing according to claim 1, wherein the first and second panes have a distance between them of at least 25 mm.

15. A method comprising arranging an insulating glazing according to claim 1 as building interior glazing, building outer glazing, and/or façade glazing.

16. The insulating glazing according to claim 1, wherein the impermeable region extends along at least 30% of the periphery of the hollow main body.

17. The insulating glazing according to claim 16, wherein the impermeable region extends along at least 50% of the periphery of the hollow main body.

18. The insulating glazing according to claim 1, wherein the hollow main body is filled with desiccant along at least 87% of its entire periphery.

19. The insulating glazing according to claim 8, wherein the gas-permeable membrane implemented as a water vapor barrier has water vapor permeability measured in accordance with the method ASTM E96-10 of more than 100 g/(day m²) and less than 300 g/(day m²).

20. The insulating glazing according to claim 19, wherein the gas-permeable membrane implemented as a water vapor barrier has water vapor permeability measured in accordance with the method ASTM E96-10 of more than 120 g/(day m²) and less than 250 g/(day m²).

21. The insulating glazing according to claim 12, wherein the cable is routed along at least 75% of the length of the region of the hollow main body impermeable to water vapor.

22. The insulating glazing according to claim 14, wherein the first and second panes have a distance between them of at least 30 mm.

23. The insulating glazing according to claim 22, wherein the first and second panes have a distance between them of at least 40 mm.
